(19) United States
(12) Patent Application Publication
(10) Pub. No.: US 2025/0193502 A1
(43) Pub. Date: Jun. 12, 2025

(54) SUBSTRATE UNIT AND IMAGE PICKUP APPARATUS

(71) Applicant: CANON KABUSHIKI KAISHA, Tokyo (JP)

(72) Inventor: SHINJI OBANA, Tokyo (JP)

(21) Appl. No.: 18/943,355

(22) Filed: Nov. 11, 2024

(30) Foreign Application Priority Data
Dec. 12, 2023 (JP) 2023-209512

(51) Int. Cl. H04N 23/54; H04N 23/52; H04N 23/55

(52) U.S. Cl. CPC H04N 23/54; H04N 23/52; H04N 23/55

(57) ABSTRACT

A substrate unit includes a first substrate, a second substrate, and a holder holding the first substrate and the second substrate. The first substrate and the second substrate are stacked in a predetermined direction using the holder. A first electronic component is disposed on a first surface of the first substrate, and a second electronic component is disposed on a second surface opposite to the first surface. A first connector connectable from outside is disposed on the second substrate. The second substrate is disposed to face the second electronic component and is fixed to the first substrate together with the holder. A second connector electrically connectable to the second substrate is disposed on the second surface of the first substrate.

### BACKGROUND

### Technical Field

The present disclosure relates to a substrate unit and an image pickup apparatus.

### Description of Related Art

Along with the spread of moving image viewing applications and moving image distribution services, a demand for image pickup apparatuses that can capture high-quality moving images has recently increased. Accordingly, a high-performance video processing IC is mounted on a control substrate inside the image pickup apparatus to suppress imaging noise and improve resolution.

Japanese Patent Laid-Open No. 2006-324444 discloses a structure mounted with a bypass capacitor near a video processing IC. Japanese Patent Laid-Open No. 2016-17967 discloses a structure mounted with a video processing IC on one side of a control substrate, and a card connector on the other side, to which a nonvolatile memory card such as an SD card is detachably attached.

The structures disclosed in Japanese Patent Laid-Open Nos. 2006-324444 and 2016-17967 cannot realize a substrate unit that has a reduced size and can provide high-performance processing.

### SUMMARY

A substrate unit according to one aspect of the disclosure includes a first substrate, a second substrate, and a holder holding the first substrate and the second substrate. The first substrate and the second substrate are stacked in a predetermined direction using the holder. A first electronic component is disposed on a first surface of the first substrate, and a second electronic component is disposed on a second surface opposite to the first surface. A first connector connectable from outside is disposed on the second substrate. The second substrate is disposed to face the second electronic component and is fixed to the first substrate together with the holder. A second connector electrically connectable to the second substrate is disposed on the second surface of the first substrate. An image pickup apparatus having the above substrate unit also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram of an image pickup apparatus according to this embodiment.

FIG. 2 is an exploded perspective view illustrating a part of the internal structure of the image pickup apparatus according to this embodiment.

FIGS. 3A and 3B are a perspective view and an exploded perspective view of a battery box unit according to this embodiment.

FIGS. 4A and 4B are an exploded perspective view of a substrate unit according to this embodiment.

FIGS. 5A and 5B are an exploded perspective view and an perspective view of a card media substrate and a holder according to this embodiment.

FIGS. 6A and 6B are layout diagrams of the main components mounted on a control substrate and the card media substrate according to this embodiment.

FIG. 7 is a sectional view of each unit component that constitutes the image pickup apparatus according to this embodiment.

FIG. 8 is an exploded perspective view of a heat dissipation function component of the image pickup apparatus according to this embodiment.

### DETAILED DESCRIPTION

Referring now to the accompanying drawings, a detailed description will be given of embodiments according to the disclosure. The embodiment described below is an example of the present disclosure, and may be properly modified or changed according to the structure of the apparatus to which the present disclosure is applied and various conditions. Each embodiment can be properly combined.

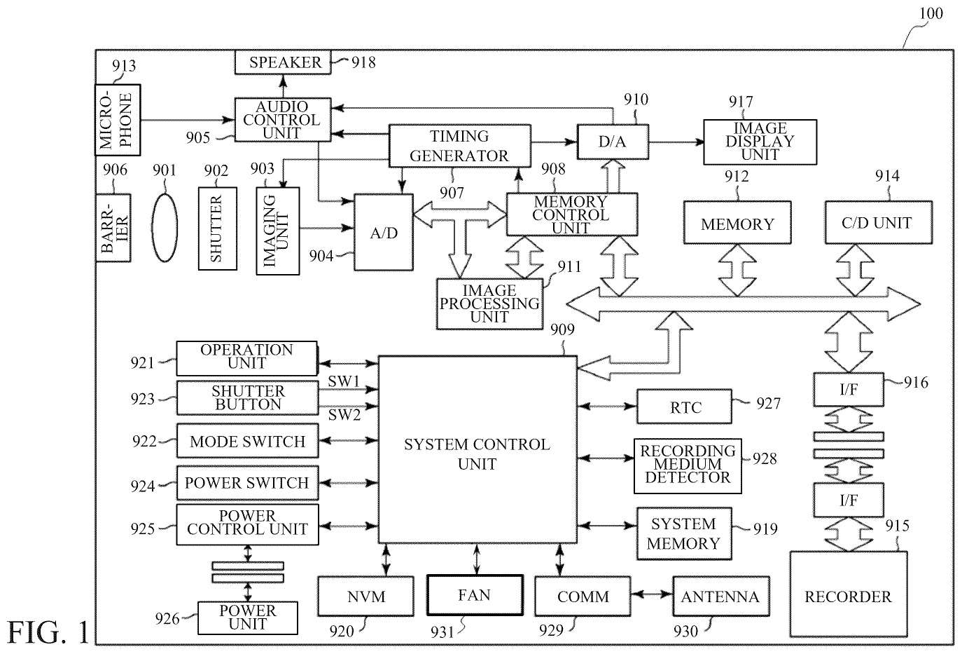

Referring now to FIG. 1, a description will be given of an image pickup apparatus 100 according to this embodiment. FIG. 1 is a block diagram of the image pickup apparatus 100. The optical system (imaging optical system) in the image pickup apparatus 100 includes a lens 901, and a shutter 902 having an aperture stop function. An imaging unit 903 includes an image sensor such as a Charge Coupled Device (CCD) sensor or a Complementary Metal Oxide Semiconductor (CMOS) sensor. The imaging unit 903 converts an optical image (object image) formed by the optical system into an electrical signal.

An analog-to-digital (A/D) converter 904 is used to convert an analog signal output from the imaging unit 903 into a digital signal, and to convert an analog signal output from an audio control unit 905 into a digital signal. A lens barrier 906 covers the imaging unit 903 including the lens 901 of the image pickup apparatus 100 to reduce dirt and damage. A timing generator 907 is controlled by a memory control unit 908 and a system control unit 909 to supply a clock signal and a control signal to the imaging unit 903, the audio control unit 905, the A/D converter 904, and a digital-to-analog (D/A) converter 910.

An image processing unit 911 performs predetermined pixel interpolation, resizing such as reduction, and color conversion processing for the output data from the A/D converter 904 and the data stored in a memory 912. The image processing unit 911 also performs a predetermined calculation for the captured image data, and the system control unit 909 performs exposure control and distance measurement control based on the obtained calculation result. Thereby, AF (autofocus) processing using the TTL (through-the-lens) method, AE (auto-exposure) processing, and EF (electronic flash or pre-flash) processing are performed. The image processing unit 911 also performs a predetermined calculation processing using the captured image data, and TTL AWB (auto white balance) processing based on the obtained calculation result.

The output data from the A/D converter 904 is written into the memory 912 via the image processing unit 911 and memory control unit 908, or directly via the memory control unit 908. The memory 912 stores information associated with images, such as audio data recorded by a microphone 913, captured still and moving images, and file headers when image files are constructed. The memory 912 has a storage capacity sufficient to store a predetermined number of still images, moving images for a predetermined period of time, and audio.

A compression/decompression (C/D) unit 914 compresses and decompresses image data using adaptive discrete cosine transform (ADCT) or the like, and is triggered by the shutter 902 to read the captured image stored in memory 912, perform compression processing, and write the processed data into memory 912. The C/D unit 914 reads a compressed image read into the memory 912 from a recorder 915 including a recording medium, performs decompression processing, and writes the processed data into the memory 912. The image data written into the memory 912 by the C/D unit 914 is converted into a file in the file processing unit of the system control unit 909, and is recorded into the recorder 915 via a recording medium interface (I/F) 916. The memory 912 also serves as a memory for displaying images, and the image data for display written into the memory 912 is displayed by an image display unit 917 via the D/A converter 910.

The audio signal output from the microphone 913 is converted into a digital signal by the A/D converter 904 via the audio control unit 905, which includes an amplifier, and then stored in the memory 912 by the memory control unit 908. On the other hand, the audio data recorded in the recorder 915 is read into the memory 912, and then the signal processed by the audio control unit 905 via the D/A converter 910 is output by a speaker 918.

The system control unit 909 controls the entire image pickup apparatus 100. A system memory 919 stores constants, variables, programs, etc. for the operation of the system control unit 909. A nonvolatile memory 920 can be electrically erased and recorded, and is, for example, an EEPROM.

Each of a shutter switch (SW1), shutter switch (SW2), and an operation unit 921 serves as an operation unit by which the user inputs various operation instructions to the system control unit 909. A mode switch 922 is used by the user to switch the operation mode of the system control unit 909 to a still image capturing mode, a continuous shooting mode, a moving image capturing mode, a playback mode, etc. The shutter switch (SW1) is turned on when a shutter button 923 provided on the image pickup apparatus 100 is half-pressed. Then, it instructs the start of an operation such as AF processing, AE processing, AWB processing, and EF processing. The shutter switch (SW2) is turned on when the shutter button 923 is fully pressed, and instructs the start of a series of imaging processing operations from reading out a signal from the imaging unit 903 to writing image data into the recorder 915.

The operation unit 921 includes various buttons and a touch panel. More specifically, the operation unit 921 includes, for example, an erase button, a menu button, a set button, and a four-way key arranged in a cross shape. In a case where the menu button is pressed, a menu screen on which various settings can be made is displayed on the image display unit 917. The user can intuitively make various settings using the menu screen displayed on the image display unit 917 and the operation unit 921. The touch of the user's finger or pen on the image display unit 917 may be detected, and an icon displayed on the image display unit 917 may be determined similarly to the operation of a switch or dial such as a button or dial. The operation member capable of detecting the rotation of a jog dial or the like may be used to perform the same operation as a bidirectional key.

A power button 924 switches the power-on and power-off of the image pickup apparatus 100. A power supply control unit 925 includes a battery detection circuit, a DC-DC converter, a switch circuit for switching the circuit block to be electrified, etc., and detects whether a battery is attached, a battery type, and the remaining battery level. It also controls the DC-DC converter based on the detection result and instruction from the system control unit 909, and supplies the required voltage for the required period to each unit including the recorder 915.

A power supply unit 926 includes a primary battery such as an alkaline battery and a lithium battery, a secondary battery such as a NiCd battery, a NiMH battery, and a Li-ion battery, and an AC adapter. The power supply unit 926 and the power supply control unit 925 are connected by a camera-side power connector. A Real Time Clock (RTC) 927 holds a power supply unit inside separately from the power supply control unit 925, and continues to measure time even when the power supply unit 926 is turned off. The system control unit 909 controls the timer using the date and time obtained from the RTC 927 at startup. A recording medium detector 928 detects whether the recorder 915 is attached to the recording medium slot. A communication unit 929 performs various communication processing such as RS232C, USB, IEEE1394, P1284, SCSI, modem, LAN, and wireless communication. The image pickup apparatus 100 can perform wireless communication with other devices (external devices) using an antenna 930 and the communication unit 929. A fan 931 is controlled by the system control unit 909 for driving (rotation/stop and rotation speed).

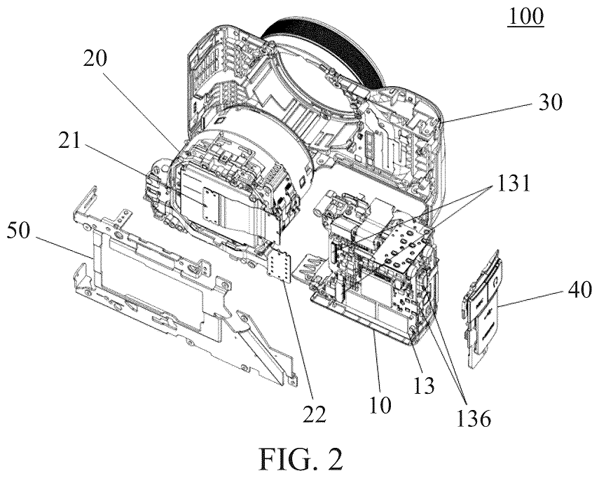

Referring now to FIG. 2, a description will be given of an outline of the internal structure of the image pickup apparatus 100. FIG. 2 is an exploded perspective view illustrating a part of the internal structure of the image pickup apparatus 100. Here, a detailed description of the overall structure of the image pickup apparatus 100 will be omitted, and only the parts required for the description of this embodiment will be described in detail.

The image pickup apparatus 100 is configured by arranging a lens barrel 20 and a battery box unit 10 adjacent to each other between a front cover 30 and a chassis 50. The battery box unit 10 includes a control substrate (first substrate) 13. A connector 131 is mounted on the control substrate 13.

Flexible printed circuits (FPCs) (boards) 21 and 22 are previously attached to the lens barrel 20. The FPCs 21 and 22 are connected to the connector 131, respectively, to electrically connect the control substrate 13 and the lens barrel 20. The battery box unit 10 also has an I/F cable connector (external interface connector) 136 to which an external I/F (interface) cable can be attached. The image pickup apparatus 100 includes a side cover 40 disposed on the side of the housing, and an opening formed in the side cover 40 exposes the I/F cable connector 136, from which the external I/F cable can be attached.

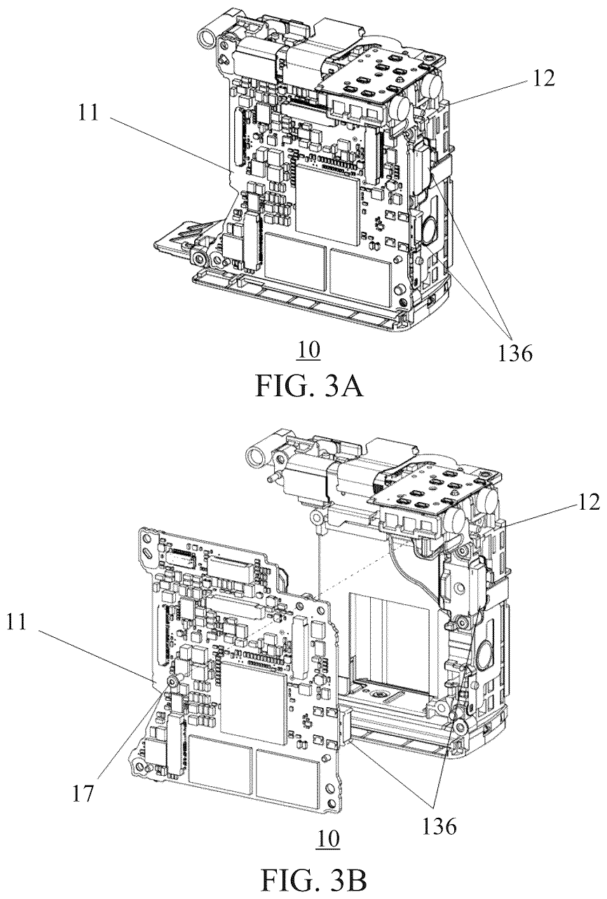

Referring now to FIGS. 3A and 3B, a detailed description of the battery box unit 10 will be given. FIG. 3A is a perspective view of the battery box unit 10. FIG. 3B is an exploded perspective view of the battery box unit 10.

The battery box unit 10 mainly includes a substrate unit (stacked unit) 11 and a battery box (housing structure) 12. The structure of the substrate unit 11 will be described in detail later. A battery box 12 includes a battery chamber capable of housing an unillustrated battery. As described above, the battery box 12 includes an I/F cable connector 136 to which an external I/F cable can be attached, an FPC on which the I/F cable connector 136 is mounted, etc. The substrate unit 11 is fixed and held in the battery box 12 by screws 17. After the substrate unit 11 is fixed to the battery box 12, wiring is performed to connect the FPC to the substrate unit 11, and the battery box unit 10 is completed.

The battery box 12 supplies power to an external device connected via an external I/F cable, for example, depending on the specification of the image pickup apparatus 100. In charging from an external power source via an external I/F cable, the battery box 12 may have a substrate mounted with an electric circuit relating to charging and power supply. The battery box 12 may further include a wireless electric circuit module and a wireless antenna module for wireless communication with an external device. Regarding each of these components, after the substrate unit 11 is fixed to the battery box 12, wiring is performed to connect them to the substrate unit 11 so that they are electrically connected to the substrate unit 11.

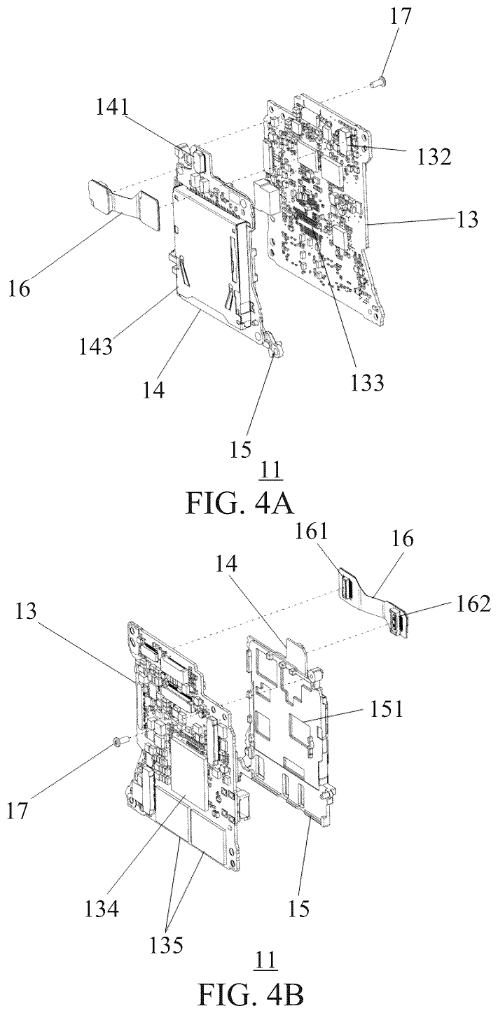

Referring now to FIGS. 4A and 4B, a detailed description will be given of the structure of the substrate unit 11. FIGS. 4A and 4B are exploded perspective views of the substrate unit 11, although FIGS. 4A and 4B are views from opposite directions.

The substrate unit 11 mainly includes a control substrate (first substrate) 13, a card media substrate (second substrate) 14, a holder 15, and an FPC 16. The control substrate 13 is mounted with a video processing IC (control circuit component, first electronic component) 134, and a memory 135. The video processing IC 134 has the functions of a system control unit 909, an image processing unit 911, a memory control unit 908, and the like (see FIG. 1). The memory 135 corresponds to the memory 912 illustrated in FIG. 1.

A plurality of electronic components (second electronic components) 133 are mounted on the surface (second surface) of the control substrate 13 opposite to its flat surface (first surface) on which the video processing IC 134 is mounted. The electronic components 133 include a passive element such as a ceramic capacitor and a chip resistor, and include, for example, a bypass capacitor (of the power supply to the video processing IC 134) electrically connected to the power terminal of the video processing IC 134. In this embodiment, when viewed from a predetermined direction (Z-axis direction), at least a part of the electronic components 133 is disposed to overlap the outer shape of the video processing IC 134.

A connector (second connector) 132 that can be electrically connected to the card media substrate 14 is mounted on the surface (second surface) of the control substrate 13 on which the electronic components 133 are mounted. The connector 132 has a substrate-to-substrate connector structure (first substrate-to-substrate connector) and is configured to be electrically connectable to an FPC 16.

The card media substrate 14 is a single-sided mounted substrate on which electronic components are mounted only on one side of the front and back substrate surfaces. The side of the card media substrate 14 that faces the control substrate 13 is defined as an unmounted surface (fourth surface), and the opposite side is defined as a mounted surface (third surface). The mounted surface includes a card connector (first connector connectable (accessible) from the outside) 143, a connector 141, and the like. That is, the card media substrate 14 has a surface (third surface) on which at least one electronic component is mounted, and a surface (fourth surface) on the opposite side of the third surface on which no electronic component is mounted, and is disposed so that the fourth surface faces the electronic component 133. In this embodiment, when viewed from the Z-axis direction, the video processing IC 134, the electronic component 133, and the card connector 143 are disposed so as to at least partially overlap each other.

The holder 15 positions the control substrate 13 in a state in which it is partially fixed and held to the card media substrate 14 in advance, and fixes and holds the two substrates, the control substrate 13 and the card media substrate 14, with the screws 17. That is, the holder 15 holds the control substrate 13 and the card media substrate 14, and the control substrate 13 and the card media substrate 14 are stacked in a predetermined direction (Z-axis direction) using the holder 15. In this embodiment, the card media substrate 14 is disposed so as to face the electronic component 133, and is fixed to the control substrate 13 together with the holder 15.

Connectors 161 and 162 are mounted on both ends of the FPC 16. Both connectors 161 and 162 have a structure of a substrate-to-substrate connector (second substrate-to-substrate connector). The connector 161 is engageable with the connector 132, and the connector 162 is engageable with the connector 141. The control substrate 13 and the card media substrate 14 are electrically connected to each other via the FPC 16. In this embodiment, the FPC 16 is disposed at a position that does not overlap the card connector 143 when viewed from the Z-axis direction. In this embodiment, a second substrate-to-substrate connector is disposed on a surface (fourth surface) of the card media substrate 14 on which no electronic components are mounted, and the first substrate-to-substrate connector is electrically connected to the second substrate-to-substrate connector.

The holder 15 has a plurality of receiving surfaces that can contact the flat surface of the control substrate 13. The control substrate 13 and the card media substrate 14 are fixed and held in parallel to each other by the holder 15. The holder 15 has a plurality of openings 151 formed in a part of the area facing the control substrate 13. In a case where the control substrate 13 is aligned with the holder 15, one of electronic components mounted on the control substrate 13, which has a certain component height or more is configured to fit inside the openings 151. At least one of the plurality of electronic components disposed on the second surface of the control substrate 13 is disposed to be exposed from the opening 151. This structure can fix and hold the control substrate 13 and the card media substrate 14 in close proximity while maintaining the rigidity of the holder 15, thereby reducing the size (thickness) of the image pickup apparatus 100.

The card media substrate 14 has a flat surface on the side facing the control substrate 13 as an unmounted surface. Thereby, the mounted component of the control substrate 13, which is configured with a relatively high component mounting density, can be disposed without taking into consideration collisions with the mounted component of the card media substrate 14. This also contributes to securing the rigidity of the holder 15 and to disposing the substrates in close proximity and securing the design freedom of the control substrate 13.

The FPC 16 electrically connecting the control substrate 13 and the card media substrate 14 forms a flexible portion between the connectors 161 and 162. In a case where the substrates are assembled, due to misalignment of the substrates and mounting shift between components, the substrates may be assembled to the holder 15 while a relative positional relationship between the connectors 141 and 132 has slightly changed.

Even if the relative positional relationship between the connectors 141 and 132 changes by a certain amount, the flexible portion of the FPC 16 absorbs the change and a stable electrical connection can be maintained. Here, the mounted surfaces of the connectors 141 and 132 are surfaces facing the object side of the image pickup apparatus 100. In a case where substrates are aligned via the holder 15, the substrate outline of the card media substrate 14 and the connector 132 mounted on the control substrate 13 are disposed without overlapping each other. Thus, due to the structure that first assembles the substrates to the holder 15 and then assembles them into the battery box unit 10, the FPC 16 can smoothly achieve connector engagement operation to both ends from one direction.

The FPC 16 achieves a compact layout having no detour or bending process of a wiring path, and a short path that covers part of one surface of the control substrate 13 and the card media substrate 14. Due to the FPC 16 having a simple and compact structure, the transmission path wired inside the FPC 16 can be wired short. The compact internal wiring transmission path of the FPC 16 contributes to maintaining signal quality because the wiring length can be shorter in forming a high-speed transmission path between the card media substrate 14 and the control substrate 13.

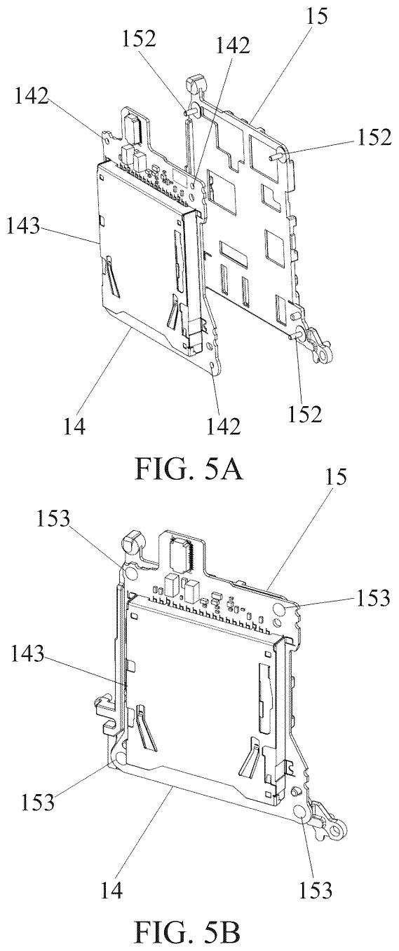

Referring now to FIGS. 5A and 5B, a description will be given of a joining structure between the card media substrate 14 and the holder 15. FIG. 5A is an exploded perspective view of the card media substrate 14 and the holder 15. FIG. 5B is a perspective view of the card media substrate 14 and the holder 15.

As described above, the holder 15 is configured to fix and hold the control substrate 13 after it has been partially fixed to the card media substrate 14 in advance. The card media substrate 14 has a plurality of through-holes 142. The holder 15 includes a caulk shaft 152 at a position facing the through-hole 142 while the card media substrate 14 and the holder 15 are aligned. In a case where the card media substrate 14 is aligned with the holder 15, the caulk shaft 152 is inserted into the through-hole 142, and the holder 15 is temporarily fixed in this state using a jig tool for thermal caulking.

The holder 15 is a molded component formed by molding resin with a die, and the caulk shaft 152 is also formed integrally with the holder 15. The caulk shaft 152 is heated and pressurized by thermal caulking to form a caulk fixing portion 153 around the through-hole 142. The card media substrate 14 is fixed and held in the holder 15 by the caulk fixing portion 153. A thermal caulk process generally uses a heat source such as ultrasonic waves, infrared rays, or electricity, but another heat source or processing method may be used to achieve fixation and holding.

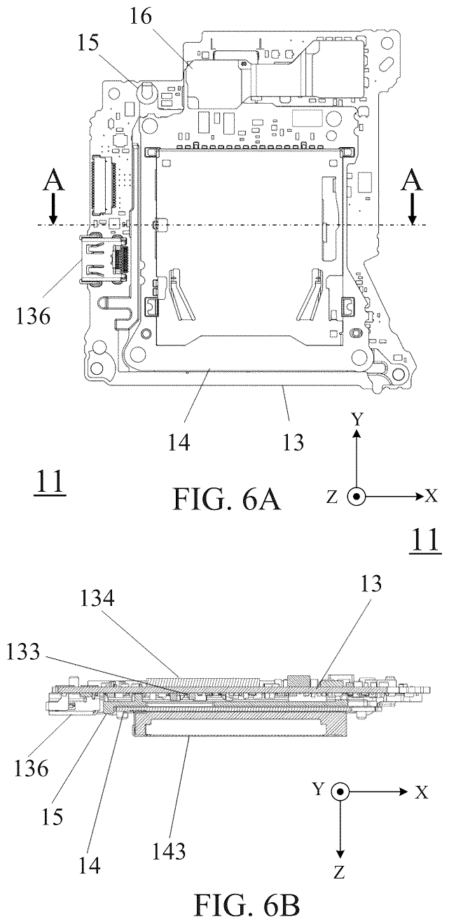

Referring now to FIGS. 6A and 6B, a description will be given of the arrangement of the components mounted on the control substrate 13 and card media substrate 14. FIGS. 6A and 6B are layout diagrams of the main components mounted on the control substrate 13 and card media substrate 14 that make up the substrate unit 11. FIG. 6A illustrates a plan view in the X-Y plane. FIG. 6B is a sectional view taken along a line A-A in FIG. 6A.

The control substrate 13 has an I/F cable connector 136 mounted on the surface on which electronic components 133 are mounted. The I/F cable connector 136 is, for example, a connector compatible with the High-Definition Multimedia Interface (HDMI) (registered trademark) standard, or a connector compatible with the Universal Serial Bus (USB) standard.

The I/F cable connector 136 is mounted on a plate end of the control substrate 13, and is mounted at a position that does not overlap the holder 15 that holds the control substrate 13 when viewed from a predetermined direction (Z-axis direction) (when viewed in the X-Y plane). The I/F cable connector 136 has a structure engageable with a cable plug, and thus has a certain amount of component height. Therefore, the I/F cable connector 136 is mounted at a position that does not overlap the holder 15 when viewed from the Z-axis direction. When viewed from the Y-axis direction in a transparent manner, the I/F cable connector 136 is configured to partially overlap the holder 15 in the Z-axis direction.

This structure can reduce the height of the substrate unit 11. When viewed from the Z-axis direction, the I/F cable connector 136 is mounted at a position where it does not overlap the card media substrate 14 and the card connector 143. When viewed from a direction perpendicular to the Z-axis direction (the X-axis direction, horizontal direction), the I/F cable connector 136, the card media substrate 14, and the card connector 143 are disposed so as to at least partially overlap one another. Therefore, the height of the substrate unit 11 can be reduced.

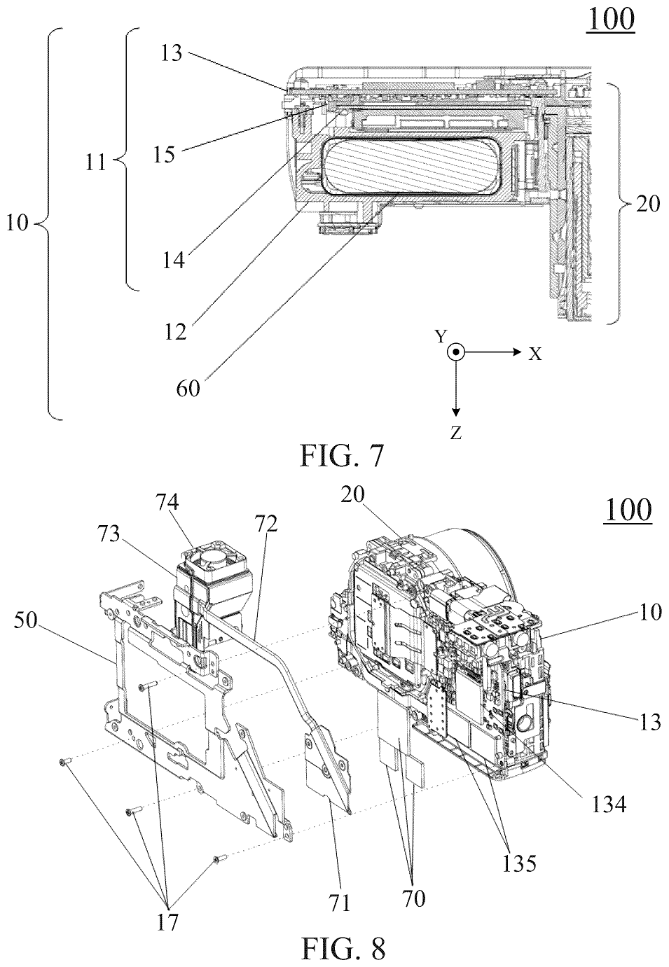

Referring now to FIG. 7, a description will be given of the arrangement of the substrate unit 11, the battery box 12, and the lens barrel 20 (each unit component or part) in the image pickup apparatus 100. FIG. 7 is a sectional view of each unit component in the image pickup apparatus 100.

As described above, the lens barrel 20 and the battery box unit 10 are disposed so as to be adjacent to each other in the direction perpendicular to the Z-axis (the X-axis direction). That is, when viewed from a direction perpendicular to the Z-axis direction (the X-axis direction), the substrate unit 11 at least partially overlaps the lens barrel 20.

The battery box 12 is configured so that a battery 60 can be housed in it. That is, inside the battery box unit 10, the control substrate 13 and card media substrate 14 in the substrate unit 11 are held so as to overlap each other in the Z-axis direction.

When viewed from the Z-axis direction, the battery 60 is stacked together with the substrate unit 11 in the Z-axis direction at a position that partially overlaps the substrate unit 11. When viewed from the Y-axis direction (vertical direction), the lens barrel 20 and these stacked components (stacked layout components) are disposed to overlap each other along the Z-axis direction.

In the image pickup apparatus 100, the battery box unit 10 plays a part of the function of a grip portion with which the user grips the image pickup apparatus 100. Accordingly, the substrate and the battery are integrally disposed in the grip portion of the image pickup apparatus 100, and when viewed from the Y-axis direction, the grip portion is configured to overlap the lens barrel 20 along the Z-axis direction. This structure does not need to dispose a substrate or a fixing member for the substrate on the rear portion of the lens barrel 20, and can reduce the thickness of the image pickup apparatus 100.

The control substrate 13 includes an video processing IC 134, a memory 135, an audio control IC, a power supply IC, a motor driver IC for driving and controlling the lens barrel 20, and its peripheral devices. Therefore, the control substrate 13 is formed of a fine wiring substrate using a method such as a build-up substrate or an any-layer substrate.

On the other hand, by mounting the card connector 143, which occupies a large mounting area, the card media substrate 14 can secure a mounting area for mounting many ICs on the control substrate 13. Circuit blocks that require fine wirings are mounted on the control substrate 13, and large mounting components that occupy a mounting area are mounted on the card media substrate 14. Thereby, the card media substrate 14 can adopt a substrate with a relatively simple layer structure, such as a double-sided wiring substrate. As a result, the manufacturing cost of the card media substrate 14 can be reduced.

Referring now to FIG. 8, a description will be given of the heat dissipation structure of the image pickup apparatus 100. FIG. 8 is an exploded perspective view of the heat dissipation functional components of the image pickup apparatus 100. A large current flows through the video processing IC 134 and memory 135 mounted on the control substrate 13 due to the image processing operation and memory control operation of the image pickup apparatus 100. As a result, heat is generated due to electrical resistance in the video processing IC 134 and memory 135 (electronic component). In a case where the image pickup apparatus 100 continues to operate for a long time without dealing with the heat generated by these electronic components, the temperature may exceed the upper limit at which the image pickup apparatus 100 operates normally, and the function may stop.

To deal with the heat generated by the video processing IC 134 and the memory 135, the image pickup apparatus 100 has a heat dissipation structure that combines a plurality of functional components. First, the image pickup apparatus 100 has a heat dissipation sheet (heat dissipation member) 70 that contacts each of the video processing IC 134 and the memory 135 and transfers heat toward the rear surface direction (rear side) of the image pickup apparatus 100. That is, the substrate unit 11 is fixed to the battery box 12 so that the video processing IC 134 faces the rear side of the image pickup apparatus 100, and the heat dissipation sheet 70 is disposed to dissipate heat generated from the video processing IC 134 to the rear side.

The heat dissipation sheet 70 has a certain amount of elasticity, and is sandwiched and fixed between a heat dissipation plate 71 and each electronic component. The heat dissipation sheet 70 is a resin sheet having thermal conductivity, and is formed by adding a filler having high thermal conductivity to a resin sheet having a certain amount of flexibility, mainly made of acrylic or silicone resin. The heat dissipation plate 71 is made of a metal having high thermal conductivity, such as copper or aluminum.

The image pickup apparatus 100 has a heat pipe 72. One end of the heat pipe 72 is joined and fixed to the heat dissipation plate 71. The other end of the heat pipe 72 is joined and fixed to heat dissipation fins 73. A fan motor 74 is disposed at a position adjacent to the heat dissipation fins 73. The fan motor 74 corresponds to the fan 931 in FIG. 1.

The heat pipe 72 is a heat conductive element that transports heat, has a tubular shape with a capillary structure on its inner wall, and is made of a metal such as copper or aluminum. A small amount of working fluid is sealed inside the tube, and is sealed under reduced pressure. If the video processing IC 134 or memory 135 generates heat and the heat dissipation sheet 70 transfers the heat to the heat dissipation plate 71 and one end of the heat pipe 72, the working fluid easily evaporates due to the reduced pressure inside the tube. The evaporated working fluid moves as a vapor flow to the other end of the heat pipe 72, which is not heated. The vapor that has moved comes into contact with the inner wall of the low-temperature tube and liquefies again. The working fluid that has returned to liquid travels through the capillary structure back to the area where it joins with the heat dissipation plate 71.

In a case where the image pickup apparatus 100 continues to operate and the video processing IC 134 and memory 135 continue to generate heat, the working fluid repeats a process of evaporation, movement, and condensation to transport heat. The heat dissipation fins 73 are a structure with a plurality of metal fins that secure a wide surface area to improve the heat dissipation efficiency, and are mainly made of metal such as copper or aluminum. There are several methods for processing the exterior of the heat dissipation fins 73, such as a die-casting method in which molten metal is poured into a mold and cast, a method in which metal fins are welded to a thin plate material, and a method in which metal fins are continuously formed without welding by bending a thin plate material at regular intervals.

The fan motor 74 receives power supply and rotates the blades fixed to the rotating shaft to perform the blowing function. By disposing the fan motor 74 at a position adjacent to the heat dissipation fins 73 and driving it, the warm air stagnating around the heat dissipation fins 73 can be blown out, and a decrease in heat dissipation efficiency can be reduced. The fan motor 74 can select one of a plurality of blowing structures depending on the rotating shaft and blowing direction, such as a propeller fan in which the intake direction and exhaust direction are in a straight line parallel to the rotating shaft, and a blower fan (sirocco fan) in which the intake direction is parallel to the rotating shaft and the exhaust duct is perpendicular to the intake direction.

The image pickup apparatus 100 forms a heat dissipation structure for electronic components that are heat sources using the heat dissipation sheet 70, the heat dissipation plate 71, the heat pipe 72, the heat dissipation fins 73, and the fan motor 74. Thereby, it becomes difficult for the image pickup apparatus 100 to stop operating even if it continues to operate for a long time. The heat dissipation structure formed by these functional components is fixed and held by the battery box unit 10, the lens barrel 20, the chassis 50, and a plurality of screws 17.

As described above, inside the battery box unit 10, the control substrate 13 and the card media substrate 14 are stacked in the Z-axis direction, and the video processing IC 134 and the memory 135 are mounted on the back side of the image pickup apparatus 100. By configuring the battery box unit 10 and the substrate unit 11 in this way, the heat dissipation sheet 70 can be simply attached to the package surface of the video processing IC 134 and the memory 135 from the rear side, and assembly can be simply made.

The heat dissipation plate 71 and the heat pipe 72 can be easily attached from the rear side, so they are unlikely to have a complex shape and each part is easy to process. If the heat pipe 72 had a complex shape, it would create resistance when the working fluid in the tube flows through the capillary structure, which could reduce the heat dissipation characteristic, so the arrangement of the functional components of the image pickup apparatus 100 also contributes to maintaining the heat dissipation characteristic. As described above, the I/F cable connector 136 mounted on the control substrate 13 is mounted on the surface facing the card media substrate 14, and is disposed so that it does not overlap the card media substrate 14 and the holder 15 when viewed from the Z-axis direction.

This structure can suppress the height of the mounted components on the mounting surface of the video processing IC 134 of the control substrate 13 and reduce the thickness of the substrate unit 11. In addition, this structure can also restrain the occurrence of the heat dissipation sheet 70 and the heat dissipation plate 71 from coming into contact with other high-profile components during assembly, from preventing close thermal bonding with the heat source. Since a larger outer shape area can be secured for the heat dissipation sheet 70 and the heat dissipation plate 71, the heat dissipation function can be improved.

While the disclosure has described example embodiments, it is to be understood that some embodiments are not limited to the disclosed embodiments. The scope of the following claims is to be accorded the broadest interpretation so as to encompass all such modifications and equivalent structures and functions.

For example, the control substrate 13 and the card media substrate 14 are electrically connected using the FPC 16, but this embodiment can use a floating connector instead. That is, one of the first substrate-to-substrate connector and the second substrate-to-substrate connector may be a floating connector. The floating connector is a substrate-to-substrate connector in which the substrate-mounted terminal portion forms a movable terminal structure (floating structure). In using a floating connector, first, one of the floating connectors is mounted on the unmounted surface of the card media substrate 14. Then, a paired floating connector is also mounted on the opposing control substrate 13 aligned via the holder 15.

Due to this structure, the floating connector can be engaged with the card media substrate 14 and the holder 15 that are previously fixed and held, while the control substrate 13 is assembled. Therefore, the number of components and the number of assembly steps can be reduced.

While the substrate unit 11 in this embodiment is used for the image pickup apparatus 100, this embodiment is not limited to this example and is applicable to an optical or electronic apparatus other than the image pickup apparatus.

Due to the structure according to this embodiment, a high-performance video processing IC can be mounted in an image pickup apparatus such as a compact digital camera without increasing the size of the image pickup apparatus. Therefore, this embodiment can provide a substrate unit and an image pickup apparatus that have a reduced size and can provide high-performance processing.

This embodiment can provide a substrate unit that has a reduced size and can provide high-performance processing.

This application claims priority to Japanese Patent Application No. 2023-209512, which was filed on Dec. 12, 2023, and which is hereby incorporated by reference herein in its entirety.

What is claimed is:

1. A substrate unit comprising:
a first substrate;
a second substrate; and
a holder holding the first substrate and the second substrate,
wherein the first substrate and the second substrate are stacked in a predetermined direction using the holder,
wherein a first electronic component is disposed on a first surface of the first substrate, and a second electronic component is disposed on a second surface opposite to the first surface,
wherein a first connector connectable from outside is disposed on the second substrate,
wherein the second substrate is disposed to face the second electronic component and is fixed to the first substrate together with the holder, and
wherein a second connector electrically connectable to the second substrate is disposed on the second surface of the first substrate.

2. The substrate unit according to claim 1, wherein the first substrate is a control substrate,
wherein the first electronic component is a control circuit component,
wherein the second electronic component is a passive element electrically connected to the control circuit component, and
wherein the first connector is a card connector.

3. The substrate unit according to claim 2, wherein the passive element is a bypass capacitor configured to supply power to the control circuit component, and
wherein the passive element is disposed to at least partially overlap an outer shape of the control circuit component when viewed from the predetermined direction.

4. The substrate unit according to claim 2, wherein the second substrate has a third surface on which at least one electronic component is mounted, and a fourth surface opposite the third surface on which no electronic component is mounted, and
wherein the second substrate is disposed so that the fourth surface faces the passive element.

5. The substrate unit according to claim 2, wherein an external interface connector is disposed on the second surface of the control substrate, and
wherein the holder and the external interface connector are disposed so as not to overlap each other when viewed from the specified direction.

6. The substrate unit according to claim 5, wherein the external interface connector, the second substrate, and the card connector are disposed so as to at least partially overlap each other when viewed from a direction perpendicular to the predetermined direction.

7. The substrate unit according to claim 2, wherein an opening is formed in a part of an area of the holder facing the control substrate, and
wherein at least one of a plurality of electronic components disposed on the second surface of the control substrate is disposed so as to be exposed from the opening.

8. The substrate unit according to claim 2, wherein the control circuit component, the passive element, and the card connector are disposed so as to at least partially overlap each other when viewed from the predetermined direction.

9. The substrate unit according to claim 2, further comprising a flexible printed circuit that electrically connects the control substrate and the second substrate, and
wherein the flexible printed circuit is disposed at a position that does not overlap the card connector and is engaged with the second connector when viewed from the predetermined direction.

10. The substrate unit according to claim 2, wherein the second connector is a first substrate-to-substrate connector,
wherein a second substrate-to-substrate connector is disposed on a fourth surface of the second substrate on which no electronic component is mounted, and
wherein the first substrate-to-substrate connector is electrically connected to the second substrate-to-substrate connector.

11. The substrate unit according to claim 10, wherein one of the first substrate-to-substrate connector and the second substrate-to-substrate connector is a floating connector.

12. An image pickup apparatus comprising:
a substrate unit; and
an image sensor,
wherein the substrate unit includes:
a first substrate;
a second substrate; and
a holder holding the first substrate and the second substrate,
wherein the first substrate and the second substrate are stacked in a predetermined direction using the holder,
wherein a first electronic component is disposed on a first surface of the first substrate, and a second electronic component is disposed on a second surface opposite to the first surface,
wherein a first connector connectable from outside is disposed on the second substrate,
wherein the second substrate is disposed to face the second electronic component and is fixed to the first substrate together with the holder, and
wherein a second connector electrically connectable to the second substrate is disposed on the second surface of the first substrate.

13. The image pickup apparatus according to claim 12, further comprising a lens barrel,
wherein the substrate unit at least partially overlaps the lens barrel when viewed from a direction perpendicular to the predetermined direction.

14. The image pickup apparatus according to claim 12, further comprising a housing structure that can house a battery for the image pickup apparatus, and
wherein the substrate unit is fixed to the housing structure.

15. The image pickup apparatus according to claim 14, wherein the substrate unit is fixed to the housing structure such that the first electronic component faces a rear side of the image pickup apparatus, and
wherein the image pickup apparatus includes a heat dissipation member configured to dissipate heat generated from the first electronic component to the rear side.
